(19) United States
(12) Patent Application Publication
(10) Pub. No.: US 2007/0050681 A1
(43) Pub. Date: Mar. 1, 2007

(54) Global user services management for system cluster

(76) Inventors: Christopher V. DeRobertis, Hopewell Junction, NY (US); George G. Behrend, New York, NY (US); Julianne F. Haugh, Austin, TX (US); Yantian T. Lu, Round Rock, TX (US)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(21) Appl. No.: 11/211,396

(22) Filed: Aug. 25, 2005

(51) Int. Cl. G06F 11/00

(52) U.S. Cl. 714/43

(57) ABSTRACT

A system cluster, a method and a recording medium are provided in which an administering host system of a cluster maintains global information for globally managing the availability of services to users on a basis of the system cluster. Individual host systems also maintain local information, the local information being usable for locally managing the availability of services or resources to users of those host systems. Thus, the availability of services to users of the cluster is managed locally for some users via referring to the local information at the host system to which the user makes a request. For other users, the availability of services is managed via referring to the global information. A table is maintained at each of the host systems which indicates for each user defined to the cluster whether the services available to the particular user are managed globally or locally.

This invention was made with government support under subcontract B519700 under prime contract W-7405-ENG-48 awarded by the Department of Energy. The Government has certain rights in this invention.

### BACKGROUND OF THE INVENTION

The present invention relates to management of the availability of services to users of a cluster of host processing systems.

The availability of resources to a particular computer user can be managed by physically controlling an amount of hardware and software allocated to the user as a stand-alone or semi-independent desktop or laptop user computer. However, for greater function, a number of such user computers are connected to other computing systems in an electronic network. These other computing systems may include computing systems designated “servers” which provide or “serve up” a variety of services and computing resources to the user computers. In addition, the user computers may have a server function, operating to provide services and computing resources to other user computers or servers in the electronic network, under certain well-defined conditions.

In a particular case, a “cluster” of computing systems includes a number of processor nodes which are electronically linked together to support inter-processor communication. As such the computing systems can cooperate together in executing certain common computing tasks. In addition, each processor node typically supports the execution of one or more operating system images known as “host systems” and is capable of independently executing certain computing tasks. In such cluster, services and computing resources can be made available to users of the cluster who log in to the cluster through any one of the host systems supported by the processor nodes.

In conventional clusters, it can be problematic to manage the services to users in a consistent way which is updateable in real time or near real time. In one conventional arrangement, information for managing user access to the cluster and its services is maintained on a “per-host” basis, i.e., maintained at each host system within the cluster. In a “files-based per-host” arrangement, each host system within the cluster retains a set of user access files having sufficient information to determine whether and under what conditions a user of the cluster has authority to access a service or use a resource within the cluster. For example, in such arrangement, a user can log in to the cluster from any one of the host systems supported by the cluster. Each host system consults the files retained on that host system to determine whether the user presents a valid user name and password combination to grant or deny access to the cluster. However, whenever a change is made to the information contained in the user access files, copies of the user access files containing the changed information have to be transmitted to and stored by every host system within the cluster. As it can take a significant amount of time to propagate the files to each host system throughout the cluster, it can be very difficult if not impossible to keep the information current on all of the host systems.

In a particular example, when a breach in security is suspected, it may be necessary to quickly block access to a particular user to all host systems of the cluster. In the above-described system, the time required to transmit updated files to all of the host systems of the cluster can allow some of the host systems to be exposed to the suspected security breach for a period of time until all of the host systems' files have been replaced by the updated files. Another way that the suspected breach might be handled is for a host system of an administrator to issue a command requiring each host system within the cluster to block access to the particular user associated with the suspected security breach. However, if there are any host systems which are not running at the time that command is issued, but begin to run later at some time after the command is issued, those host systems will not have received the command. Thus, the security of those host systems could remain vulnerable unless the administrator keeps issuing the same command again and again to block access to the particular user.

In one example, a “central management station” operating at one processor node of a cluster maintains a file registry for controlling user access to the cluster. The central management station propagates copies of files from the file registry to all host systems of the cluster. However, a problem arises in that the central management station is the only entity allowed to make changes to the user access control information. This can be a problem, as it is frequently desirable to change user access to certain services on a particular host system or the cluster from that particular host system. In addition, when access to services and resources are managed only centrally, it may not be possible for a particular host system to grant additional access to certain users to services or resources of that particular host system.

### SUMMARY OF THE INVENTION

According to an aspect of the invention, a method is provided for managing availability of services to a plurality of users of a cluster which includes a plurality of host processing systems or “host systems”. In such method, an administering host system of a cluster maintains global information for globally managing the availability of services to users on a basis of the system cluster. Individual host systems also maintain local information, the local information being usable for locally managing the availability of services or resources to users of those host systems. Thus, the availability of services to users of the cluster is managed locally for some users via referring to the local information at the host system to which the user makes a request. For other users, the availability of services is managed via referring to the global information. A table is maintained at each of the host systems which indicates for each user defined to the cluster whether the services available to the particular user are managed globally or locally. When a user requests access to a service at one of the host systems, the local information is referenced to determine availability of the service to the user when the table indicates that the availability of services to that user are managed locally. Conversely, the global information is referenced when the table indicates that the availability of services to that user are managed globally.

According to another aspect of the invention, a recording medium is provided having information recorded thereon for performing a method of managing the availability of services to a plurality of users of a cluster which includes a plurality of host processing systems or “host systems”. In such method, an administering host system of a cluster maintains global information for globally managing the availability of services to users on a basis of the system cluster. Individual host systems also maintain local information, the local information being usable for locally managing the availability of services or resources to users of those host systems. Thus, the availability of services to users of the cluster is managed locally for some users via referring to the local information at the host system to which the user makes a request. For other users, the availability of services is managed via referring to the global information. A table is maintained at each of the host systems which indicates for each user defined to the cluster whether the services available to the particular user are managed globally or locally. When a user requests access to a service at one of the host systems, the local information is referenced to determine availability of the service to the user when the table indicates that the availability of services to that user are managed locally. Conversely, the global information is referenced when the table indicates that the availability of services to that user are managed globally.

According to another aspect of the invention, a system cluster is provided which includes an administering host processing system or “host system” and a plurality of other host systems. The administering host system is operable to maintain a repository of global information relating to availability of at least a first service to respective users of the system cluster. The other host systems of the system cluster are operable to communicate with the administering host system, each of the other host systems being operable to maintain local information at those host systems that relates to availability locally of at least one of the first service or a second service to respective users of each of the other host systems. Each of the other host systems maintains a table which includes information indicating for each of the respective users whether availability to the at least one of the first service or the second service is managed globally or managed locally. In this way, when the table indicates that the availability to the user of a requested service is managed locally, the local information is checked to determine the availability, and when the table indicates that the availability to the user of a requested service is managed globally, the global information is checked to determine the availability.

### BRIEF DESCRIPTION OF THE DRAWINGS

FIG. 1 is a block diagram illustrating a system cluster and components thereof, in accordance with one embodiment of the invention;

FIG. 2 is a flow chart illustrating a method of managing user access to services within a cluster in accordance with one embodiment of the invention; and

FIG. 3 is a flow chart illustrating a method of altering information used to manage user access to services within a cluster in accordance with a particular embodiment of the invention.

### DETAILED DESCRIPTION

According to embodiments of the invention described herein, a cluster of host systems is provided in which changes to user access to a service within the cluster are managed from a single point of administration. The term “users” includes both natural persons, e.g., humans who are allowed access to utilize services and resources of a cluster, as well as daemons. A daemon is a program that runs continuously and exists for the purpose of handling periodic service requests that a computer system expects to receive. As an example, a hypertext transfer protocol daemon used in a server of pages on the Web or on an http enabled intranet continually waits for requests to come in from users.

In accordance with the embodiments of the invention, a host system of the cluster performs an administering function in maintaining global information that is used for globally managing the availability of services to users on a basis of the system cluster.

In addition, local information is maintained at individual host processing systems, the local information being usable for locally managing the availability of services or resources to users of those host processing systems. Thus, the availability of services to users of the cluster is managed locally for some users via the local information at the host processing system to which the user makes a request. For other users the availability of services is managed from an administering host processing system via the global information. The services which are managed locally can include the same service and/or a different service from that which is managed globally using the global information. A table is maintained at each of the host processing systems which indicates for each user defined to the cluster whether the services available to the particular user are managed globally or locally. Thus, when a user requests access to a service at one of the host processing systems, the local information is referenced when the table indicates that services to that user are managed locally and the global information is referenced when the table indicates that services to that user are managed globally.

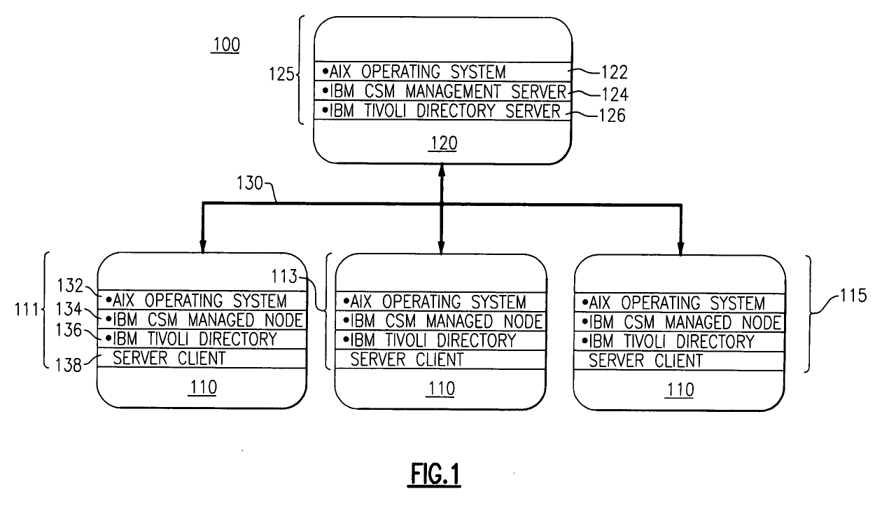

FIG. 1 is a block diagram illustrating the structure of a cluster 100 in accordance with an embodiment of the invention. In such cluster, each of a plurality of processor nodes 110, 120 are linked via an electronic network 130 to support communications between processor nodes. Through such communications, the processor nodes 110, 120 are able to cooperate together in executing certain common computing tasks. In addition, each processor node typically is capable of independently executing certain computing tasks. Each processor node typically is allocated a set of hardware resources, e.g., local processor hardware, local storage and input/output resources. In addition, each processor node is configured to execute one or more operating system images. The hardware resources of the processor node are divided and allocated to each of the operating system images that execute on the processor node such that each operating system image is said to operate in a “logical partition” of the processor node.

One processing node 120 of the cluster is configured to support the function of an administering host processing system 125 or “host system” for the cluster. Such processing node 120 typically includes one or more components, e.g., software components which are different or have been configured to behave differently from other like software components of other host processing systems of the network. In this case, an operating system 122 such as that licensed under the mark AIX® (registered trademark of International Business Machines Corporation) runs on the processor node 120. In addition, other components such as IBM® (registered mark of International Business Machines Corporation) CSM (cluster system management) server software 124 and IBM Tivoli® (registered mark of International Business Machines Corporation) Directory Server software 126, also referred to as “lightweight directory access protocol” (“LDAP”) server are configured to run in the administering host system 125. Being thus configured, the administering host system preferably functions as a “single point of administration” (“SPOA”) for all of the host systems in the cluster. As the SPOA, the administering host system maintains global information which usable by each of the host systems to manage the services available to users at any host system within the cluster.

The software components which run in the administering host system 125 are somewhat different from those which run in other host processing systems 111, 113 and 115 or “host systems” of the cluster 100. These “other” host systems 111, 113 and 115 operate as clients of the administering host system 125. The other host systems are able to refer to the global information maintained by the administering host system in order to manage the availability of services to users at any of the host systems within the cluster 100. In a preferred embodiment, the other host systems preferably execute an operating system 132 such as that licensed under the mark AIX. These other “client” host systems execute a “managed client” software component 134 for managing host systems of a cluster such as that licensed under the mark IBM CSM managed node, and also include directory client software 136 such as that sold under the mark IBM Tivoli® Directory. The managed client software and the directory client software enable the client host system to reference global information in the administering host system when a user requests access to a service of the cluster from any of the client host systems—for example, the user logs in to one of the client host systems.

An additional “server client” software component 138 is also preferably executed on each client host system. The server client software 138 is used in establishing an authenticated connection between the client host system and the administering host system to perform limited server functions such as allowing a particular user at one of the client host systems to make changes in information contained in a “shell” or “gecos”. A shell contains information such as a user name and password which needs to be known by the cluster for the user to use the services of the cluster. A “gecos” is defined as other user information such as a user's office location which does not need to be known for the user to use the cluster.

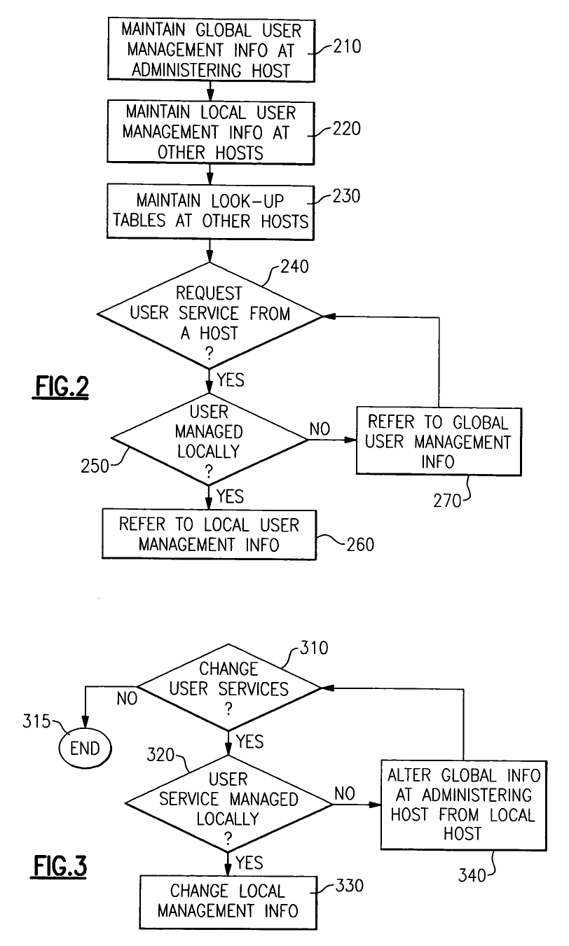

With reference to FIG. 2, operation of the cluster 100 will now be described according to one embodiment of the invention. In step 210, global information for managing user access to services within the cluster is maintained at the administering host system, using the server CSM management software 124 and server directory software 126 described above. Preferably, information is maintained on a “per-user” basis such that sufficient information regarding every user of the cluster and the user's access to services and resources of the cluster are maintained in the administering host system, which functions as the SPOA for the cluster. In such case, any changes to the information regarding a particular user, e.g., the shell and gecos, can be made at any time with confidence that the changed information will appear the same to all host systems in the cluster.

In step 220, local information for managing a particular user's special access to services on a particular host system is maintained by client directory software and managed node software at certain client host systems (e.g., client systems 111, 113, 115; FIG. 1) of the cluster where the particular user has the special access. A particular user may be granted special access to services on a particular client host system in order to allow the user to operate that client host system when it is starting up and has not yet established a network connection to the administering host system of the cluster. In addition, a particular user of a client host system may be given access to certain resources of that client host system, e.g., higher access to files of the client host system, higher access to operate the client host system in certain ways or a higher access than other users to use memory, processors and input output resources of the particular client host system. In such case, information regarding the particular user's access to services and resources of that particular client host system is maintained locally at the client host system by the above-described software components. In addition, because the information relates only to access to the local client system by the particular user, it need only be kept at the local client system.

As part of a process of managing the availability of services to users of the cluster, in block 230 a look-up table is maintained at each of the client host systems of the cluster. The look-up table is referenced upon a request by a particular user for a service at a particular one of the client host systems, e.g., the user logging in or the user wishing to use a service such as ftp, telnet, etc. Reference to the look-up table is made to determine whether the information regarding that user's access is maintained locally at the particular client host system or if the information is maintained globally by the administering host system.

Thus, in block 240, it is determined whether a request is made for a service by a particular user at one of the client host systems. For example, a particular user name and password may be presented at a login screen at the client host system. If such request is made, in block 250 the look-up table maintained at the client host system is referenced to determine whether information for managing access by that particular user is managed locally. If the look-up table indicates that the user's access is managed locally, in block 260 the local user management information is referenced in response to the user's request. In such case, the component software on the local client system refers to the local information and manages the user's access to services on that local client system directly. Otherwise, if the look-up table does not indicate that the user's access is managed locally, in block 270 reference is made to the global user management information maintained by the administering host system. In such case, the component software on the local client host system makes a call to the administering host system (125; FIG. 1) and obtains the information regarding the particular user from the global information that is maintained by the administering host system.

In a variation of the above-described embodiment, a portion of the global information maintained by the administering host system as a SPOA is cached locally in the client host system. The cached information can relate to only a set of users for which information that was recently accessed by the local client host system from the administering host system or it can relate to a larger number of users. Through use caching rules at the local host, one can mark cached information stale on every access, or one can indicate the freshness of the information by the amount of time which has elapsed since the cached information was stored locally. The cached information can even be pushed from the globally stored information by the administering host system to the client host systems in accordance with some schedule. Since the pushed information is always considered only a cached version of the global information that is maintained by the administering host system, such cached information is subject to being declared stale or invalid through normal caching rules. Moreover, the rules for declaring the cached information stale or invalid can be changed at any time in accordance with the topography of the cluster and to suit the performance goals of the cluster. Thus, one can always count on the information at the SPOA being reliable, and with proper control of the caching algorithm, client host systems can refer to a locally cached copy of the cached information with confidence.

In another variation of the above-described embodiment, to improve performance in large clusters, copies of all the global information are maintained by one or more “replica servers” in the cluster. The replica servers handle requests for global information so as to reduce the number of requests made to each such server. In such case, the replica servers respond to requests for user access information from copies of the global information maintained by them. However, the replica servers preferably do not permit the user access information to be changed that is contained in their copies of the global information, such that the administering host system remains a SPOA for the cluster.

FIG. 3 illustrates a method for changing the availability of services to a user within a system cluster in accordance with an embodiment of the invention. In such method, a way is provided for the information regarding a user's access to be changed without having to access the administering host system directly. In such case, change access to the global information is provided from one of the client host systems. Thus, in block 310, it is determined whether a request is made to change information regarding a user's access to services of the cluster. For example, this can include a change in the user's shell, e.g., user name and/or password. If no such request is made, the method terminates at block 315. Next, at block 320 it is determined whether the information regarding that user's access is managed locally or globally. Similar to the method described above relative to FIG. 2, a look-up table is consulted to determine whether the information is managed locally or globally. If the information is managed locally at the client host system, in block 330 the locally managed information is changed. However, when the information is managed globally at the administering host system, in block 340 the globally managed information will be changed.

Certain constraints must apply to the ways in which changes are made to the globally managed information in order to avoid possible unintended or unauthorized deletion or destruction of records. In a cluster, it is a security exposure to have all LDAP client host systems of the cluster have access as a directory administrator in binding to a directory server on the administering host system. In such case, the LDAP client host system could not only change information relating to users at that client host system, but for all other users of the cluster, as well.

To overcome this, each client host system is permitted access to change the global information only by requesting the services of a special proxy account which acts for the client host system. The proxy account is given the proper privilege for supporting changes in user login access control, but is not given any privilege to modify user attributes which are unnecessary to make the requested changes to the user information. The following lists the privileges of the LDAP client, root, and users when the LDAP client utilizes the proxy account access to change the globally maintained information from the client host system.

An LDAP user can change one's own password.

An LDAP user can change one's own gecos (typically a user's full name) and shell, but not any other fields.

LDAP user login activities will be logged to LDAP, including a terminal identifier, a host system identifier, the time of last successful/failed login, and a count of failed login attempts, if any.

Note that under certain circumstances, an LDAP client can have super authority, i.e., be granted permission as a directory administrator from the client host system. In such case, the directory administrator operates as a “local root user” or privileged process. However, even then the privileges of the directory administrator client to change information from the client host system are limited as follows:

Local root user/privileged process can change password for a LDAP user.

Local root user/privileged process can change the gecos and shell.

Local root user/privileged process can change whether login activities will be logged.

Local root user/privileged process can not change any other user attributes.

Local root user/privileged process can not create/delete user/group accounts.

Privileges can be modified to suit the particular needs of the cluster. Under this approach, it is also possible to create multiple proxy user accounts, each with different privilege sets for configuring different groups of client systems.

While the invention has been described in accordance with certain preferred embodiments thereof, those skilled in the art will understand the many modifications and enhancements which can be made thereto without departing from the true scope and spirit of the invention, which is limited only by the claims appended below.

What is claimed is:

1. A method of managing availability of services to a plurality of users of a cluster including a plurality of host processing systems, each host processing system being allocated one or more electronic processors within said cluster, comprising:
maintaining global information by an administering host processing system of said system cluster, said global information usable to globally manage availability of a first service to said users on a basis of said system cluster;
maintaining local information at respective ones of said plurality of host processing systems, said local information usable by said respective ones of said plurality of host processing systems to manage availability to users of at least one of said first service or a second service at said respective ones of said plurality of host processing systems;
maintaining a table at each of said plurality of host processing systems, said table including information indicating for each of the plurality of users whether availability to said at least one of said first service or said second service is managed globally or managed locally; and
in response to a request from a user at one of said plurality of host processing systems for at least one of said first service or said second service, referring to said local information to determine said availability when said table indicates that said availability to the user is managed locally and referring to said global information to determine said availability when said table indicates that said availability to the user is managed globally.

2. The method as claimed in claim 1, further comprising caching at least a portion of said global information relating to said availability to the user maintained by said administering host processing system in said one host processing system.

3. The method as claimed in claim 1, further comprising copying a portion of said global information relating to said availability to the user from said administering host processing system to said one host processing system in response to said request from the user when said table indicates that said availability is managed globally.

4. The method as claimed in claim 1, further comprising altering a first portion of said global information relating to the user from said one host processing system while preventing alteration of a second portion of said global information relating to at least some of the plurality of users other than the user.

5. The method as claimed in claim 4, further comprising recording one or more transactional details of said step of altering said first portion of said global information, said one or more transactional details including at least one of an identifier identifying an input terminal, an identifier identifying the one host processing system, a time of login for performing said step of altering, or a number of failed attempts to login for performing said step of altering.

6. The method as claimed in claim 1, further comprising permitting the user to alter a portion of said local information relating to the user at said one host processing system while preventing the user from altering a portion of said global information relating to at least some of the plurality of users other than the user.

7. The method as claimed in claim 1 wherein said first service includes at least one of alteration of shell attributes of the user, file transfer protocol (“ftp”), telecommunications network protocol (“telnet”), remote shell, and remote and local login services.

8. A recording medium having information recorded thereon for performing a method of managing availability of services to a plurality of users of a cluster including a plurality of host processing systems, each host processing system being allocated one or more electronic processors within said cluster, said method comprising:
maintaining global information by an administering host processing system of said system cluster, said global information usable to globally manage availability of a first service to said users on a basis of said system cluster;
maintaining local information at respective ones of said plurality of host processing systems, said local information usable by said respective ones of said plurality of host processing systems to manage availability to users of at least one of said first service or a second service at said respective ones of said plurality of host processing systems;
maintaining a table at each of said plurality of host processing systems, said table including information indicating for each of the plurality of users whether availability to said at least one of said first service or said second service is managed globally or managed locally; and
in response to a request from a user at one of said plurality of host processing systems for at least one of said first service or said second service, referring to said local information to determine the availability when said table indicates that said availability to the user is managed locally and referring to said global information to determine said availability when said table indicates that said availability to the user is managed globally.

9. The recording medium as claimed in claim 8, wherein said method further comprises caching at least a portion of said global information relating to said availability to the user maintained by said administering host processing system in said one host processing system.

10. The recording medium as claimed in claim 8, wherein said method further comprises copying a portion of said global information relating to said availability to the user from said administering host processing system to said one host processing system in response to said request from the user when said table indicates that said availability is managed globally.

11. The recording medium as claimed in claim 8, wherein said method further comprises altering a first portion of said global information relating to the user from said one host processing system while preventing alteration of a second portion of said global information relating to at least some of the plurality of users other than the user.

12. The recording medium as claimed in claim 11, wherein said method further comprises recording one or more transactional details of said step of altering said first portion of said global information, said one or more transactional details including at least one of an identifier identifying an input terminal, an identifier identifying the one host processing system, a time of login for performing said step of altering, or a number of failed attempts to login for performing said step of altering.

13. The recording medium as claimed in claim 8, wherein said method further comprises permitting the user to alter a portion of said local information relating to the user at said one host processing system while preventing the user from altering a portion of said global information relating to at least some of the plurality of users other than the user.

14. The recording medium as claimed in claim 8, wherein said first service includes at least one of alteration of shell attributes of the user, file transfer protocol (“ftp”), telecommunications network protocol (“telnet”), remote shell, and remote and local login services.

15. A system cluster, comprising:
an administering host processing system, said administering host processing system operable to maintain a repository of global information relating to availability of at least a first service to respective users of said system cluster;
a plurality of other host processing systems of said system cluster operable to communicate with said administering host processing system, each of said plurality of other host processing systems operable to maintain local information at said plurality of other host processing systems relating to availability locally of at least one of said first service or a second service to respective users of each of said plurality of other host processing systems, each of said plurality of other host processing systems maintaining a table including information indicating for each of the respective users whether availability to said at least one of said first service or said second service is managed globally or managed locally, such that when said table indicates that said availability to the user of a requested one of the first or second service is managed locally, said local information is checked to determine said availability, and when said table indicates that said availability to the user of a requested one of the first or second service is managed globally, said global information is checked to determine said availability.

16. The system cluster as claimed in claim 15, wherein at least some of said plurality of other host processing systems are operable to cache at least a portion of said global information relating to said availability to the user.

17. The system cluster as claimed in claim 15, wherein at least some of said plurality of other host processing systems are operable to copy a portion of said global information relating to said availability to the user from said administering host processing system into storage maintained at said plurality of other host processing systems when said table indicates that said availability is managed globally.

18. The system cluster as claimed in claim 15, wherein at least some of said plurality of other host processing systems are operable to alter a first portion of said global information relating to the user while preventing alteration of a second portion of said global information relating to at least some of the plurality of users other than the user.

19. The system cluster as claimed in claim 18, wherein at least one of said at least of said plurality of other host processing systems and said administering host processing system is operable to record one or more transactional details for altering said first portion of said global information, said one or more transactional details including at least one of an identifier identifying an input terminal, an identifier identifying the one host processing system, a time of login for performing said step of altering, or a number of failed attempts to login for performing said step of altering.

20. The system cluster as claimed in claim 15, wherein at least some of said plurality of other host processing systems are operable to permit the user to alter a portion of said local information relating to the user said at said some host processing systems while preventing the user from altering a portion of said global information relating to at least some of the plurality of users other than the user.
